(19) United States
(12) Patent Application Publication
(10) Pub. No.: US 2011/0134368 A1
(43) Pub. Date: Jun. 9, 2011

(54) SYSTEM AND METHOD FOR PROVIDING BACKLIGHT USING A DIRECTIONAL REFLECTIVE SURFACE

(75) Inventor: Estill Thone Hall, JR., Fishers, IN (US)

(73) Assignee: Shenzhen TCL New Technology Ltd., Shekou, Shenzhen, Guangdong (CN)

(21) Appl. No.: 13/058,242

(22) PCT Filed: Nov. 21, 2008
(86) PCT No.: PCT/US2008/084374

§ 371 Date: Feb. 9, 2011

(30) Foreign Application Priority Data
Aug. 13, 2008 (CN) 200810135168.8

(51) Int. Cl. G02F 1/1335; G02F 1/13357

(52) U.S. Cl. 349/64; 362/97.1; 349/67; 349/70

(57) ABSTRACT

The present embodiments are directed to a backlight illumination system. The backlight illumination system includes a light source adapted to uniformly emit light in numerous directions for illuminating a display unit. The backlight illumination system further includes a reflector disposed behind the light source, wherein the reflector is adapted to reflect the uniformly emitted light along a desired direction to provide backlight illumination to the display unit.

### FIELD OF THE INVENTION

The present embodiments relate generally to video display systems. More specifically, the present embodiments relate to backlight illumination of video display systems, such as liquid crystal displays (LCDs).

### BACKGROUND OF THE INVENTION

This section is intended to introduce the reader to various aspects of art, which may be related to various aspects of the present embodiments that are described and/or claimed below. This discussion is believed to be helpful in providing the reader with background information to facilitate a better understanding of the various aspects of embodiments of the present invention. Accordingly, it should be understood that these statements are to be read in this light, and not as admissions of prior art.

Liquid crystal display (LCD) panels are prevalently employed in a variety of display systems. Such systems include, flat screen computer monitors, lap tops, hand-held devices, flat screen television sets (TVs), digital watches, and so forth. The LCD panel incorporated in such systems typically includes a matrix of transistors and additional microdevices acting as electrical switches that filter and modulate white light, also referred to as backlight, which illuminates the LCD panel.

The modulation of the backlight may be performed by changing its polarization using a polarizing filter located between the source of the backlight and the LCD panel. As the individual microdevices of the LCD panel may change polarization upon energization, these microdevices may be configured to have a perpendicular polarization (cross polarization) to the polarizing filter when energized. The cross polarization will block the light at the energized microdevices. In other configurations, the microdevices may be configured to align with the polarization of the polarizing filter upon energization, which will allow light to be emitted through the energized microdevices. Thus, the action of such devices incorporated within the LCD panel in combination with the backlight may facilitate illumination of numerous individual pixels with color-filtered light that combine to produce viewable colored images.

The backlight used for illuminating a traditional LCD panel is typically provided by a plurality of fluorescent tubes, which are typically disposed behind the LCD panel. Because light generated by such fluorescent tubes is generally emitted uniformly within the display device, the LCD panel which is disposed at one end of the device may receive only a portion the uniformly emitted light. This portion of the light may be insufficient for providing proper backlight illumination such that the LCD panel can produce a proper image.

Further, proper image generation depends also on the extent to which the backlight provided by the fluorescent tubes can be polarized before reaching the LCD panel. The ability of the display system to polarize the backlight depends on the angular distribution of the light signals when those light signals impinge a polarizer disposed within the LCD system. Accordingly, angular distribution of the uniformly emitted light signals may be too wide, resulting in backlight illumination that is only partially polarized. With badly polarized light, the brightness may substantially increase. Additionally, the black state may also increase an equal amount, leading to reduced contrast. This degraded quality could render related images unpleasant and objectionable for viewing. For example, a bright state of 1000 and a dark state of 1 gives 1000/1=1000 contrast. In a degraded example, the bright and dark states may each increase by 5, a bright state of 1005 and a dark state of 6 gives 1005/6=167 contrast, which is poor quality.

Current techniques, such as employing white surfaces and heavy diffusion devices for enhancing the backlight, have proven costly and inefficient. Therefore, there is a need for systems and methods for improving aspects of backlight illumination of LCD devices.

### BRIEF DESCRIPTION OF THE DRAWINGS

Advantages of presently disclosed embodiments may become apparent upon reading the following detailed description and upon reference to the drawings in which:

FIG. 1 is a block diagram of a display system in accordance with an exemplary embodiment;

FIG. 2 is a block diagram of another display system in accordance with an embodiment;

FIG. 3 is perspective view of a holographic mirror and a fluorescent tube, in accordance with an exemplary embodiment; and

FIG. 4 is a process flow diagram showing a method for providing backlight to a display system, in accordance with an exemplary embodiment.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

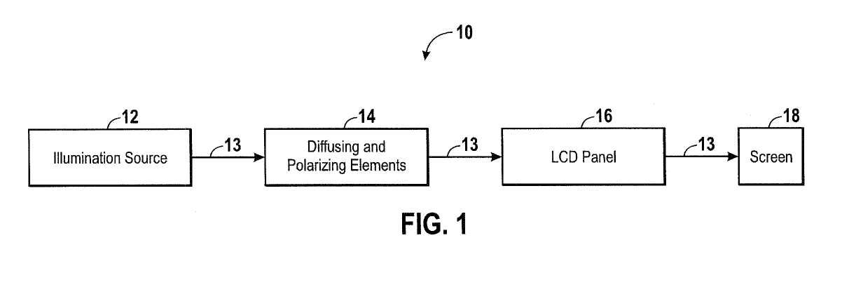

Turning initially to FIG. 1, a block diagram of a display system in accordance with present embodiments is illustrated and generally designated by reference numeral 10. In the illustrated embodiment, the display system 10 may comprise an LCD monitor or the like used in computers, TVs or the like.

The display system 10 includes an illumination source 12. As discussed further below, the illumination source 12 may include fluorescent bulbs or other light producing devices configured to generate white or colored light for providing backlight illumination for the display system 10. The light may be generally directed along an image path 13 to facilitate producing an image on the display system 10. The illumination source 12 may also include additional components, such as a directional reflective surface. For example, the directional reflective surface may include a beveled mirror, or one or more holographic reflectors or mirrors adapted to efficiently reflect light generated by the light producing devices in a desired direction, such as towards an LCD panel along the image path 13. Thus, in accordance with present embodiments, the illumination source 12 may utilize a holographic mirror to more efficiently utilize the backlight of the display system 10 for generating images. Further, robust light-reflection capability, as provided by the aforementioned holographic mirror, may facilitate a reduction in the physical dimensions of the display system 10 relative to display systems that do not employ holographic mirrors. This reduction in the size of the display system 10 may further facilitate a reduction in a number of fluorescent bulbs used within the illumination system 12 which, in addition, may lower the cost of the display system 10 relative to other display systems.

In the illustrated embodiment, the display system 10 includes diffusing and polarizing elements 14. The diffusing and polarizing elements 14 may be adapted to diffuse the light emanating from the fluorescent bulbs of the illumination source 12. In so doing, the diffusing elements 14 may act to smooth or smear the backlight to create a uniform backlight distribution across an LCD panel 16. Further, the polarizing devices disposed within the elements 14 may be adapted to uniquely polarize the light generated by the illumination source 12. By virtue of being polarized, the light arriving at the LCD panel 16 may enhance image-contrast, thereby improving an image quality provided by the display system 10.

Further, in the illustrated embodiment, the LCD panel 16 is disposed in a position such that light emitted from the illumination source 12 passes through the diffusing and polarizing elements 14 before reaching the LCD panel 16. In other embodiments, the diffusing and polarizing elements 14 may not be utilized. As will be appreciated by those skilled in the art, the LCD panel 16 may be made up of a passive or an active display matrix or grid. In one exemplary embodiment, the LCD panel 16 may comprise an active matrix utilizing thin film transistors (TFTs), disposed along pixel intersections of a grid comprising the display matrix. The luminance of the pixels of the LCD panel 16 may be controlled via gating actions produced by the TFTs. In another exemplary embodiment, the LCD panel 16 may comprise a passive matrix employing a grid of conductors, whereby the pixels are disposed along intersections of the display matrix. In such an embodiment, the pixels may be controlled by current driven across two conductors disposed along the grid comprising the matrix of pixels. Accordingly, LCD panels, such as the LCD panel 16, having either active or passive matrices, may be adapted to modulate and filter the backlight produced by the light emitter (for example, one or more florescent bulbs) of the illumination source 12 for producing images viewable on a screen 18.

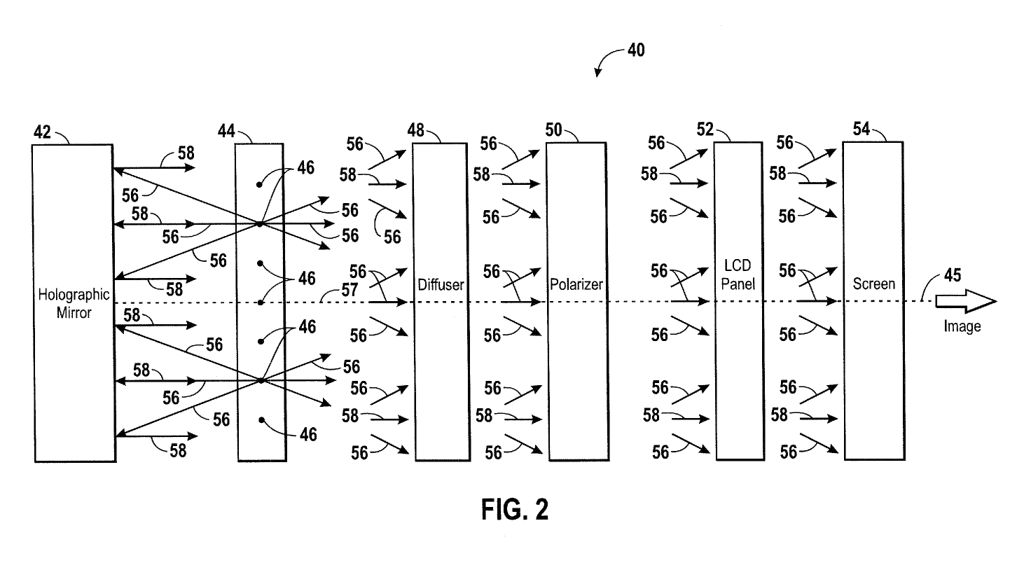

FIG. 2 is a block diagram of another display system in accordance with present embodiments. Specifically, FIG. 2 illustrates components of a display unit 40, such as those used in the LCD display system 10 of FIG. 1. The representation of the display system or display unit 40 in FIG. 2 depicts components included within an LCD system, and the manner in which such components function relative to one another.

As illustrated by FIG. 2, a holographic mirror 42 may be disposed at one end of the display unit 40. As further illustrated, the display unit 40 may include an illumination plate 44 disposed subsequent to the holographic mirror 42 along an image path 45. The plate 44 may include one or more light sources, such as LEDs or fluorescent tubes or light bulbs. For example, in the illustrated embodiment, the plate 44 is illustrated as including fluorescent tubes 46. The fluorescent tubes 46 are adapted to generate a backlight, such as a white light, for the display unit 40. Those skilled in the art will appreciate that the number of fluorescent tubes 46 of the plate 44 may vary according to design, operational, and/or cost-effective goals. In the illustrated embodiment, the holographic mirror 42 is adapted to reflect light generated by the plate 44 in a desired direction (e.g., a direction that is generally perpendicular to a main plane of the holographic mirror 42 or to other planar components of the display unit 40). Indeed, the holographic mirror 42 is configured to reflect light along the image path 45, which may also represent an axis of the display unit 40.

Further, the display unit 40 includes a diffuser 48 and a polarizer 50, both of which are disposed subsequent to the plate 44 along the image path 45. In the illustrated embodiment, the diffuser 48 is disposed before the polarizer 50 along the image path 45. The diffuser 48 may include an opaque material adapted to smooth/smear and, thus, uniformly distribute the light emerging from the fluorescent tubes 46 across the display system 40. For example, the diffuser 48 may include an opaque screen. The polarizer 50 may include a polarizing material, such as a polymer or a similar material. The polarizer 50 may be disposed within the display unit 40, such that its polarization axis is oriented along a preferred direction relative to the diffuser 48. Accordingly, the polarizer 50 may be configured to polarize the backlight emanating from the fluorescent tubes 46 along the preferred direction. It should be noted that by reflecting the backlight with the holographic mirror 42 in the preferred direction, present embodiments may efficiently utilize available light. Further, it should be appreciated that the display unit 40 may not include or may include more than one diffuser and/or polarizer, such as the diffuser 48 and polarizer 50, respectively.

The display unit 40 of the illustrated embodiment further includes an LCD panel 52 disposed subsequent to the polarizer 50 along the image path 45. The LCD panel 52 may include the active-type or the passive-type components, such as those described above in relation to the LCD panel 16 (FIG. 1). Further, the LCD panel 52 may be adapted to form a viewable image by selectively filtering and modulating the smeared and polarized backlight provided by the fluorescent tubes 46 and the other system components. Selectively filtering and modulating may include cross polarizing with respect to the polarized back light, such that light may be selectively blocked from certain pixels. Once an image is formed by the LCD panel 52, the image may be transmitted to the screen 54, which may include a polarizer that further polarizes the light to provide the image.

As further illustrated by FIG. 2, the fluorescent tubes 46 may be adapted to emit light generally uniformly in all directions within the unit 40. Particularly, the amount of light propagating backwards toward the holographic mirror 42 may be essentially equivalent to the amount of light propagating forward toward the LCD panel 52. Thus, to substantially maximize the amount of backlight provided to the LCD panel 52, it may be desirable to reflect as much backward-propagating light as possible towards the LCD panel 52. This may be achieved in accordance with present embodiments by the holographic mirror 42, which may be adapted to reflect the backward-propagating light generally along a preferred forward direction, such as along the image path 45.

The light emission and reflection process discussed above is illustrated by representative light rays 56 initially emitted by the fluorescent tubes 46 at various angles and then reflected by the holographic mirror 42 in directions substantially parallel to the image path 45. As illustrated, the light rays 56 are emitted forward, backward and in other directions generally uniformly within the display unit 40. That is, the light rays 56 emerging from the fluorescent tubes 46, propagate at varying angles relative to the image path 45, which may represent an axis of the display unit 40, as represented in FIG. 2. Those skilled in the art will appreciate that the illustrated angles of propagation of the light rays 56 within the system 40 are exemplary and that in actuality a wide distribution of such angles exists, typically spanning 360 degrees.

As illustrated, a portion of the light rays 56 may propagate backward until that portion of rays impinge the holographic mirror 42. Due to the wide angular distribution, most of the light rays 56 impinge the holographic mirror 42 such that those rays are disposed at an angle relative to the image path 45. Once the rays 56 reflect from the holographic mirror 42 they propagate in a forward direction towards the LCD panel 52, as illustrated light rays 58. As further illustrated, the light rays 58 are reflected generally perpendicularly forward relative to the mirror 42, that is, generally parallel to the image path 45. Thus, rather than scattering (for example, reflecting from the holographic mirror 42 at an angle), as otherwise achieved by conventional reflecting plates, the backward propagating light rays 56 reflect forward (light rays 58), such that they can more effectively reach the LCD panel 52. This increases the amount of backlight propagating forward, thereby further illuminating the LCD panel 52 and producing an enhanced image. Another advantage provided by the holographic mirror 42 is that it minimizes the angle at which light rays impinge the polarizer 50. This enables the polarizer 50 to efficiently polarize the backlight and, thus, improve the contrast of the image produced by the display unit 40. Additionally, the use of the holographic mirror 42 can lead to an overall decrease in size of the display unit 40, as less space may be required for capturing back reflected light having a reduced scattering radius. In addition, as more light is gathered by the LCD panel 52 per fluorescent tube 46, less fluorescent tubes 46 may be needed per display system. This also may contribute to the cost effectiveness of display systems, such as those employing the above holographic mirrors/reflectors 42.

Hence, after reflection by the holographic mirror 42, the light rays 58 may propagate forward together with the rays 56 that were initially emitted along the image path 45 toward the diffuser 48 and polarizer 50. Thereafter, the polarized and diffused light may reach the LCD panel 52 to form an image. The image may then be polarized once more by the screen 54, which may include a polarizer. In some embodiments, the screen may be separate from a secondary polarizer which polarizes the image before providing the viewable image to the screen 54.

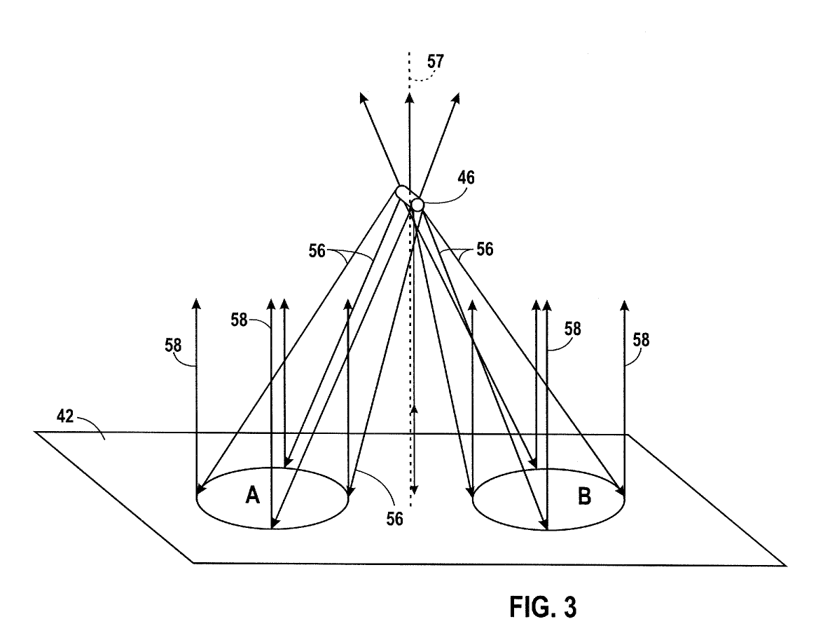

FIG. 3 is perspective view of the holographic mirror 42 and the fluorescent tube 46 in accordance with present embodiments. FIG. 3 illustrates spatial relationships between the holographic mirror 42, the fluorescent tube 46, and the emitted and reflected light rays 56 and 58, respectively. While the illustrated embodiment may depict a single fluorescent tube, it should be noted that other embodiments incorporate multiple fluorescent tubes, such as those of the plate 44, subsequently disposed with respect to the holographic mirror 42 along the image path 45, as shown in FIG. 2. Again, it should be noted that angles of incoming and reflected light rays 56 and 58 relative to the image path 45, as illustrated in the present embodiment, are merely exemplary.

As illustrated, the fluorescent tube 46 may be disposed somewhat away from the holographic mirror 42, such that the light rays 56 may deviate at varying angles from the fluorescent tube 46 as they impinge the holographic mirror 42. Those skilled in the art will appreciate that the fluorescent tube 46 is not an infinitesimal light-emitting point, but rather a tubular structure of finite size comprised of multiple light emitting points. As illustrated, the light rays 56 may impinge the holographic mirror 42 such that those rays encompass varying solid angles, shown as solid angles A and B. The solid angles A and B characterize the optimal orientation of the tube 46 relative to the reflector 46 for maintaining the perpendicular reflection of the light rays 58 relative to the holographic reflector 42 without loss of light reflection. The holographic mirror 42 may be configured to direct light, which may have been received from various angles with respect to the holographic mirror 42, along a path generally normal to the main plane of the holographic mirror 42, as illustrated in FIG. 3. In other words, as would be understood by one of ordinary skill in the art, the holographic mirror 42 may be configured to reflect light, which may have been received at various angles, in a consistent direction. This direction may be generally parallel to an axis of a display unit, such as along the image path 45 illustrated in FIG. 2. As would be understood by one of ordinary skill in the art, configuring such a holographic mirror 42 may include any of various techniques.

The extent of the solid angles A and B formed by the incoming light rays 56 may generally determine the extent to which those light rays are able to impinge the holographic mirror 42 to produce the perpendicularly emitted light rays 58 (light rays emitted in a direction substantially perpendicular to a main plane of the holographic mirror 42). This in turn may be influenced, for example, by the distance of the fluorescent tube 46 from the holographic mirror 42. This distance and the extension of the solid angles A and B can be manipulated so as to maximize the light reflection from the holographic mirror 42. Again, by maximizing the amount of light reflected towards the LCD panel, less fluorescent tubes may be required by a display system, such as the display unit 40, to obtain a minimum light emission level, consequently, reducing device complexities, power consumption and the like.

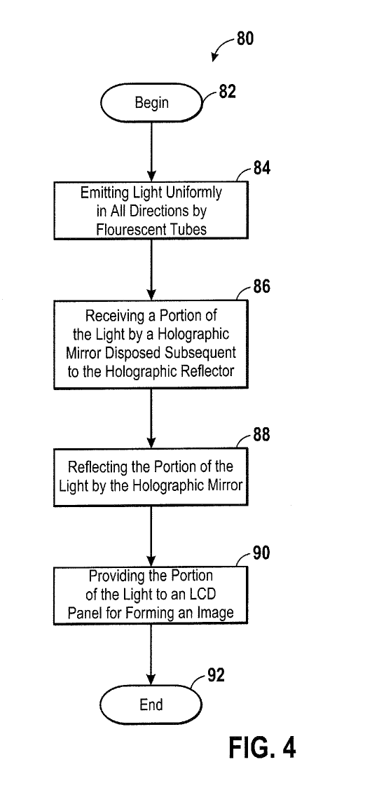

FIG. 4 is a process flow diagram showing a method for providing backlight to a display unit in accordance with present embodiments. The method is generally indicated by reference number 80. The method 80 can be applied to the display systems 10 and 40 described above in relation to FIGS. 1-3. For example, the method may be performed based on instructions or code stored in a computer-readable or machine-readable medium, such as a memory, of the display systems 10 and 40.

The method 80 begins at block 82. Process flow then proceeds to block 84, where light is emitted substantially uniformly in all directions by a plurality of fluorescent tubes, such as the fluorescent tubes 46 of the LCD display unit 40. Thereafter, the method 80 proceeds to block 86, whereby a portion of the emitted light is received by a holographic reflector, such as the holographic mirror 42 (FIG. 2). As discussed above, this portion of the emitted light propagates backward away from the fluorescent tube, i.e., away from the LCD panel and toward the holographic mirror.

Next, the process flow 80 proceeds to block 88, where the holographic mirror reflects the back-propagating portion of the light forward. This forward reflection is performed in a preferred direction relative to the uniformly emitted light and the holographic reflector, that is, along an axis of the display system, such as the image path 45 of the display unit 40. Accordingly, in one embodiment, at block 88 the light is reflected perpendicular to the holographic reflector such that it becomes parallel to the display unit. Thereafter, at block 90, the uniformly emitted light of block 84 and the perpendicularly reflected light of block 88 propagate forward toward the LCD panel where those light signals are combined to form an image.

While embodiments of the present invention may be susceptible to various modifications and alternative forms, specific embodiments have been shown by way of example in the drawings and are described in detail herein. However, it should be understood that embodiments of the invention are not intended to be limited to the particular forms disclosed. Rather, present embodiments are to cover all modifications, equivalents and alternatives falling within the spirit and scope of the invention as defined by the following appended claims.

What is claimed is:

1. A backlight illumination system, comprising:
a light source adapted to substantially uniformly emit light in various directions for illuminating a display unit;
a reflector disposed behind the light source, wherein the reflector is configured to reflect the light in a direction substantially parallel to a preferred path to provide backlight illumination for the display unit.

2. The system of claim 1, wherein the display unit is a liquid crystal display (LCD).

3. The system of claim 1, wherein the light source comprises at least one fluorescent tube.

4. The system of claim 2, wherein the at least one fluorescent tube is disposed on a plate.

5. The system of claim of claim 1, wherein the reflector is a holographic mirror.

6. The system of claim 1, wherein the reflector is configured such that reflected light propagates substantially linearly between the reflector and a liquid crystal display (LCD) panel of the display system.

7. The system of claim 6, wherein the preferred path is perpendicular to the reflector and the LCD panel.

8. The system of claim 1, comprising a light diffuser disposed subsequent to the light source along the preferred path.

9. The system of claim 8, comprising a polarizer disposed subsequent to the light diffuser along the preferred path.

10. A method for providing backlight illumination to a substantially planar display unit comprising:
emitting light substantially uniformly in a plurality of directions by a light source of the display unit, wherein a portion of the light is directed to a reflector and a portion of the light is emitted toward the substantially planar display unit;
reflecting the portion of the light directed to the reflector in a preferred direction substantially perpendicular to the substantially planar display unit; and
forming an image with the light.

11. The method of claim 10, comprising emitting the light with a plurality of fluorescent tubes

12. The method of claim 10, comprising reflecting the light with a holographic mirror.

13. The method of claim 10, comprising reflecting the light along an axis of the substantially planar display unit.

14. The method of claim 10, comprising forming the image with an LCD panel

15. The method of claim 10, comprising diffusing and polarizing the light.

16. A display unit, comprising:
a backlight illumination system, comprising:
a light source configured to substantially uniformly emit light in a plurality of directions;
a reflector disposed behind the light source, wherein the reflector is adapted to reflect the light in a consistent direction;
an image panel configured to define an image by selectively filtering the light; and
a screen adapted to project the image.

17. The display unit of claim 16, wherein the light source comprises at least one fluorescent tube.

18. The display unit of claim of claim 16, wherein the reflector comprises a holographic mirror.

19. The display unit of claim 16, comprising a light diffuser disposed subsequent to the light source.

20. The display unit of claim 19, comprising a polarizer disposed subsequent to the light diffuser.
